(19) United States
(12) Patent Application Publication
(10) Pub. No.: US 2019/0211625 A1
(43) Pub. Date: Jul. 11, 2019

(54) SECURE LADDER

(71) Applicant: Shmulik Shimon, Plantation, FL (US)

(72) Inventor: Shmulik Shimon, Plantation, FL (US)

(21) Appl. No.: 16/240,755

(22) Filed: Jan. 6, 2019

Related U.S. Application Data
(60) Provisional application No. 62/614,434, filed on Jan. 7, 2018.

(51) Int. Cl. E06C 7/42; E06C 1/18

(52) U.S. Cl. CPC E06C 7/423; E06C 7/188; E06C 1/18

(57) ABSTRACT

A secure ladder, that may include a first ladder section; wherein the first ladder section comprises a first leg, a second leg, and first rungs that extend between the first leg and the second leg; a second ladder section; wherein the second ladder section comprises a third leg, a fourth leg, and second rungs that extend between the third leg and the fourth leg; a pivoting mechanism that pivotally couples the first ladder section to the second ladder section; a blocker that is arranged to selectively prevent the ladder from being positioned in a folded position; and a supporting element that extends above the first and second ladder sections.

### CROSS REFERENCE

This application claims priority from US provisional patent filing date Jan. 7, 2018 Ser. No. 62/614,434.

### BACKGROUND

A ladder may allows a user mounted on the ladder to move the ladder to the left or to the right without dismounting from the ladder. A ladder includes ladder sections that are pivotally coupled to each other. US patent application 20080078615 titled “Ladder” provides an example of a ladder.

A user that wishes to move the ladder to a certain side has to use his legs to (a) push one ladder section towards the other ladder section, and (b) push the other ladder section away from the ladder section.

The ladder is less stable that a fixed ladder and mounting on the ladder may be risky. Furthermore—the ladder can collapse when one ladder sections is pushed towards the other ladder section.

There is a growing need to provide a secure ladder.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is an example of a ladder;

FIG. 2 is an example of a ladder;

FIG. 3 is an example of a ladder;

FIG. 4 is an example of a ladder;

FIG. 5 is an example of a ladder;

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

The term “comprising” is synonymous with (means the same thing as) “including,” “containing” or “having” and is inclusive or open-ended and does not exclude additional, unrecited elements or method steps.

The term “consisting” is a closed (only includes exactly what is stated) and excludes any additional, unrecited elements or method steps.

The term “consisting essentially of” limits the scope to specified materials or steps and those that do not materially affect the basic and novel characteristics.

In the claims and specification any reference to the term “comprising” (or “including” or “containing”) should be applied mutatis mutandis to the term “consisting” and should be applied mutatis mutandis to the phrase “consisting essentially of”.

There is provided a secure ladder that may include a first ladder section, a second ladder section and a pivoting mechanism. The first ladder section may include a first leg, a second leg, and first rungs that extend between the first leg and the second leg. The second ladder section may include a third leg, a fourth leg, and second rungs that extend between the third leg and the fourth leg. The pivoting mechanism may pivotally couple the first ladder section to the second ladder section. A user that is mounted on the ladder may rotate the first ladder section in relation to the second ladder section thereby progressing to the left or to the rights—without dismounting from the secure ladder.

The secure ladder is secure in the sense that it may include at least some of the following elements (a) one or more stabilizing elements, (b) a blocker for preventing the secure walking element from being positioned in a folded position, (c) a supporting element that hay be held by a user when the user mounts on the secure ladder and may also support color trays or other objects—while maintaining these objects away from the legs of the user (when mounted on the secure ladder), and (d) a limiter for maintaining a predefined angular range between the first and second ladder section.

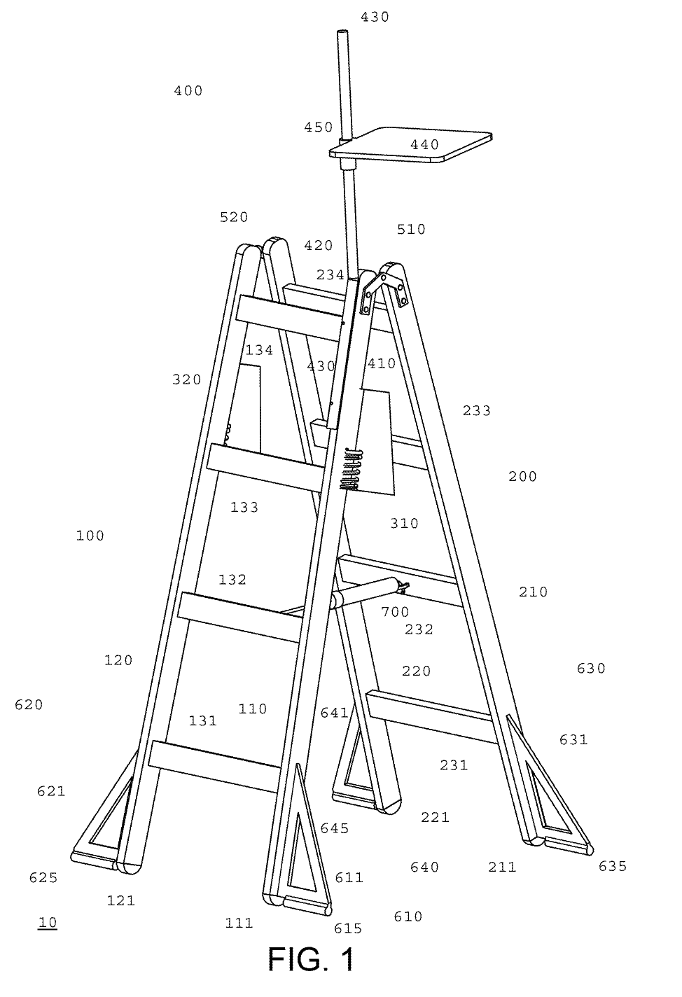

FIG. 1 illustrates a secure ladder 10.

Secure ladder 10 includes:
a. First ladder section 100.
b. Second ladder section 200.
c. Pivoting mechanisms 510 and 520.
d. At least one out of
   i. One or more blockers such as blockers 310 and 320.
   ii. Limiter 700.
   iii. One or more stabilizing elements such as stabilizing elements 610, 620, 630 and 640.

First ladder section 100 may include first leg 110, second leg 120 and first rungs 131, 132, 133 and 134 that extend between first leg 110 and second leg 120.

Second ladder section 200 may include third leg 210, fourth leg 220, and second rungs 131, 132, 133 and 134 that extend between third leg 210 and fourth leg 220.

The number of rungs may differ from four. Typically, the number of rungs is a function of the length of the legs of the ladder. When a user is mounted on the secure ladder his knees may interface with the higher rungs while stepping on the lower rungs.

The upper rungs (for example 133 and 134) may be more parallel to the longitudinal axes of the first and second legs than the lower rungs (for example 131 and 132).

The higher rungs (for example 133 and 134) may be parallel to a longitudinal axes of the first and second legs, while the lower rungs (for example 131 and 132) may be normal to the longitudinal axes of the first and second legs—or at least may have an upper portion that may extend inwardly and may be normal to the longitudinal axes of the first and second legs

Pivoting mechanisms 510 and 520 pivotally couple first ladder section 100 to second ladder section 200.

Pivoting mechanism 510 pivotally joins first leg 110 and third leg 210.

Pivoting mechanism 520 pivotally joins second leg 120 and fourth leg 220.

Any pivoting mechanism may be used. For example—each one of pivoting mechanisms 510 and 520 may include a hinge.

Blocker 310 is arranged to selectively prevent the ladder from being positioned in a folded position. Selectively prevention involves preventing the ladder from being positioned in a folded position—when positioned in a blocking position—and not preventing the ladder from folding when positioned in an unblocking position. The is positioned in a folded position when the first and second ladder sections contact each other and are parallel to each other. Under this conditions the ladder (without additional support) may be unstable.

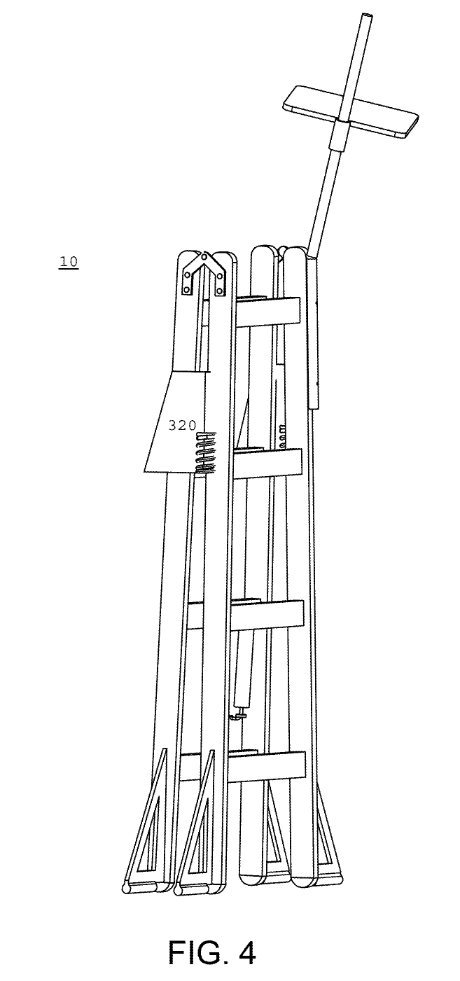

Blocker 310 is configured to move between (a) a blocking position (illustrated in FIG. 1) in which the blocker 310 is positioned, within a plane defined by the first leg and the third leg, and between the first leg and the third leg, and (b) an unblocking position (illustrated in FIG. 4) in which the blocker is positioned outside the plane defined by the first leg and the third leg. In FIG. 4 blocker 310 outwardly extends from first leg.

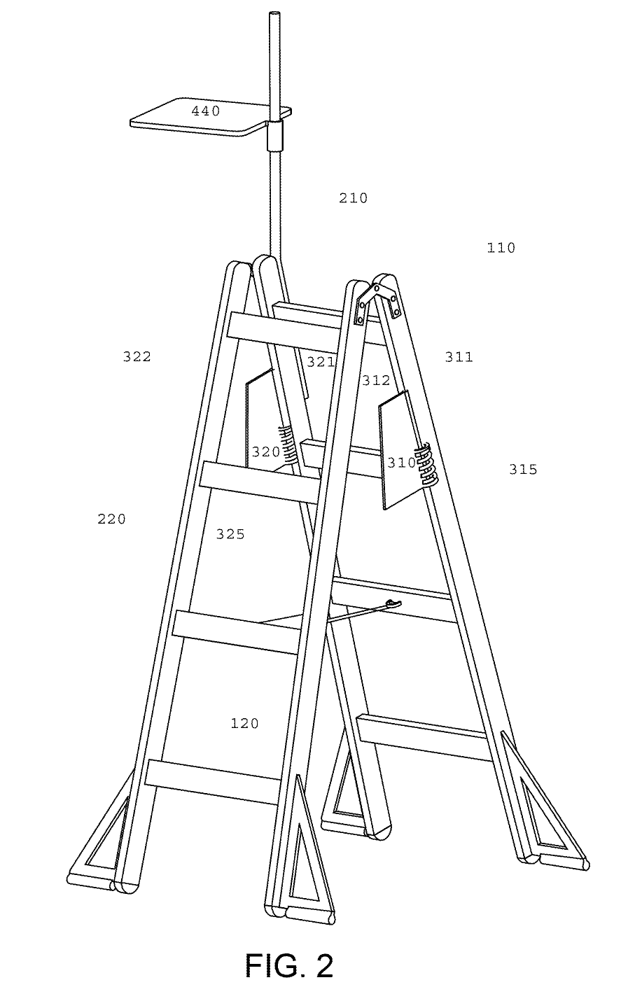

Blocker 310 can be moved in any manner between the blocking position and unblocking position. In FIG. 1 blocker 310 is pivotally coupled (via hinge—denoted 315 in FIG. 2) to the first leg 110 and is configured to pivot between the blocking position and the unblocking position.

Blocker 310 may be positioned in any location. FIG. 1 illustrates blocker 310 as being positioned at an upper half of the ladder.

The blocker may have any shape or size. In FIGS. 1 and 2 the blocker is a plate that includes a first edge 311 and a second edge 312. First edge 311 is oriented by a predefined angle to second edge 312. This predefined angle defines the minimal angle between the first and third legs when blocker 310 is in a blocking position. When blocker 310 is positioned in the blocking position and the first leg and the third leg reach the blocker then the first edge 311 contacts the first leg and the second edge 312 contacts the third leg.

Additional blocker 320 is arranged to selectively prevent the ladder from being positioned in a folded position. Selectively prevention involves preventing the ladder from being positioned in a folded position—when positioned in a blocking position—and not preventing the ladder from folding when positioned in an unblocking position. The is positioned in a folded position when the first and second ladder sections contact each other and are parallel to each other. Under this conditions the ladder (without additional support) may be unstable.

Additional blocker 320 is configured to move between (a) a blocking position (illustrated in FIG. 1) in which the additional blocker 320 is positioned, within a plane defined by the second leg and the fourth leg, and between the second leg and the fourth leg, and (b) an unblocking position (illustrated in FIG. 4) in which the blocker is positioned outside the plane defined by the second leg and the fourth leg. In FIG. 4 additional blocker 320 outwardly extends from second leg.

Additional blocker 320 can be moved in any manner between the blocking position and unblocking position. In FIG. 1 additional blocker 320 is pivotally coupled (via hinge—denoted 325 in FIG. 2) to the third leg 110 and is configured to pivot between the blocking position and the unblocking position.

Additional blocker 320 may be positioned in any location. FIG. 1 illustrates additional blocker 320 as being positioned at an upper half of the ladder.

The additional blocker may have any shape or size. In FIGS. 1 and 2 the additional blocker is a plate that includes a first edge 321 and a second edge 322. First edge 321 is oriented by a predefined angle to second edge 322. This predefined angle defines the minimal angle between the second and fourth legs when additional blocker 320 is in a blocking position. When additional blocker 320 is positioned in the blocking position and the second leg and the fourth leg reach the blocker then the first edge 321 contacts the second leg and the the second edge 322 contacts the fourth leg.

In FIG. 1 the blocker and the additional blocker are parallel to each other when positioned in their respective blocking position. In FIG. 4 the blocker and the additional blocker are non-parallel to each other when positioned in their respective nonblocking position. Any other angular relationships may exists between blocker 310 and additional blocker 320.

The additional blocker and the blocker may be positioned outside a space defined by the first, second, third and fourth legs, when the additional blocker and the blocker are positioned in the unblocking position.

FIG. 1 illustrates fours stabilizing elements—first stabilizing element 610, second stabilizing element 620, third stabilizing element 630 and fourth stabilizing element 640. There may be any number of stabilizing elements.

First stabilizing element 610 is fixed to the first leg, second stabilizing element 620 is fixed to the second leg, third stabilizing element 630 is fixed to the third leg and fourth stabilizing element 640 is fixed to the fourth leg.

There may be any number of stabilizing elements.

The stabilizing elements may be connected to the lower parts of the legs or may be connected to any part of the ladder.

Each one of first till fourth stabilizing elements may include one or more bottom surfaces that are shaped and positioned to contact the surface on which the secure ladder is positioned. Especially—each one of the one of first till fourth stabilizing elements may have bottom interfaces—such as at least one bottom surfaces that are aligned with the bottom end of the first till fourth legs respectively.

First stabilizing element 610 has at least one first bottom surface 615 that is aligned with a bottom end 111 of the first leg.

Second stabilizing element 620 has at least one second bottom surface 625 that is aligned with a bottom end 211 of the second leg.

Third stabilizing element 630 has at least one third bottom surface 635 that is aligned with a bottom end 121 of the third leg.

Fourth stabilizing element 640 has at least one fourth bottom surface 645 that is aligned with a bottom end 221 of the fourth leg.

First stabilizing element 610 may include a first triangular frame 611 that extends outwardly from the first leg. The first triangular frame is connected to the first leg and to the at least one first bottom surface 615.

Second stabilizing element 620 may include a second triangular frame 621 that extends outwardly from the second leg. The second triangular frame is connected to the second leg and to the at least one second bottom surface 625.

Third stabilizing element 630 may include a third triangular frame 631 that extends outwardly from the third leg. The third triangular frame is connected to the third leg and to the at least one third bottom surface 635.

Fourth stabilizing element 640 may include a fourth triangular frame 641 that extends outwardly from the fourth leg. The fourth triangular frame is connected to the fourth leg and to the at least one fourth bottom surface 645.

Supporting element 400 extends above the first and second ladder sections. Supporting element 400 includes base 410, base holder 430 and an upper structural element 420. Base holder 430 is connected to the first leg. Base 410 is coupled to the base holder 430 and to the upper structural element 420.

Base holder 430 is configured to hold the base. For example—base 410 may be configured to be inserted through one or more spaces defined by the base holder. These one or more spaces may include multiple coaxial spaced apart rings.

A support element 440 may be coupled to upper structural element 420 and may be height adjustable. Accordingly, the support element 440 may be fixed at any height—or at least may be fixed at multiple heights. The support element 440 may be fixed using locking element 450 for locking and unlocking the support element. An example of a locking element may include a bolt and a threaded opening.

The upper structural element may be a plate. The plate is positioned outside a space defined by the four legs of the secure ladder—and does not interrupt the movement of the ladder by the user.

Limiter 700 may be configured to prevent the first and second ladder sections from getting too close to each other (by enforcing at least a predefined minimal angle between the first and second ladder sections) or being too far away from each other (by enforcing a predefined maximal angle between the first and second ladder sections).

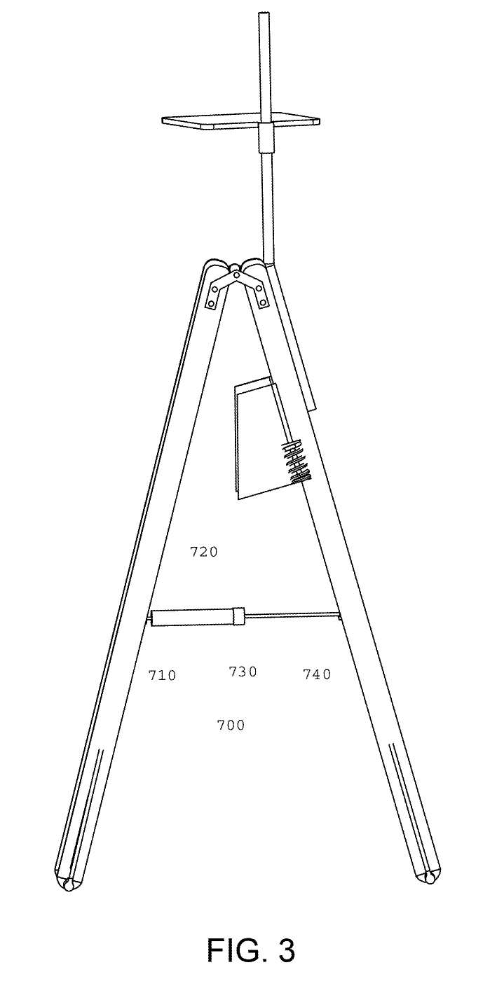

FIG. 3 is a side view of the secure ladder—when positioned in an unfolded position. This figure illustrates limiter as including a first hinge 710, a telescopic rod that include first and second parts 720 and 730, and a second hinge 740.

FIG. 4 is a side view of the secure ladder—when positioned in a folded position. Blocker 320 extends outwardly.

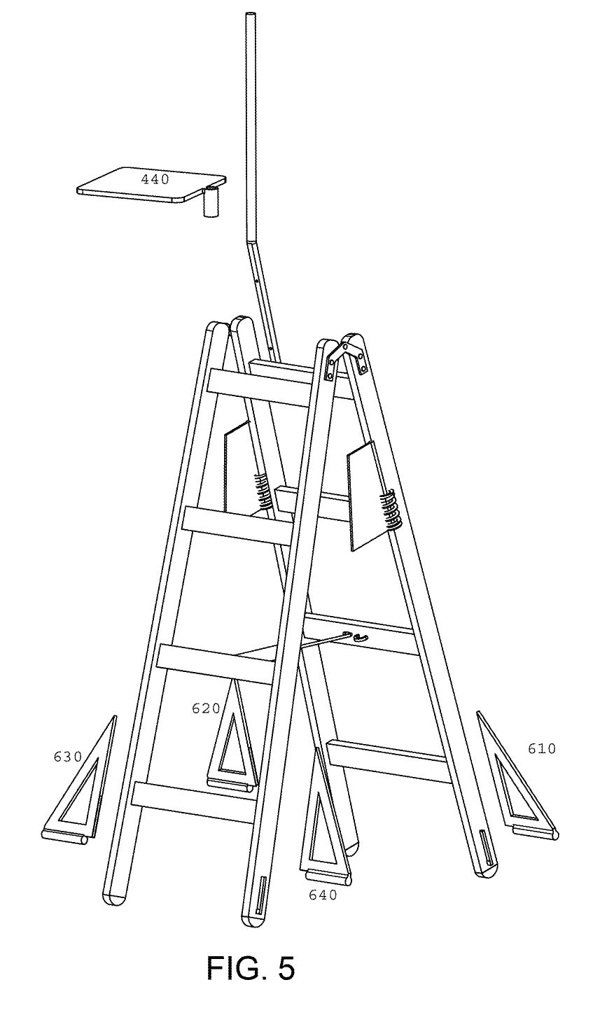

FIG. 5 illustrates stabilizing elements that are not connected to the legs of the secure ladder.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A secure ladder, comprising:
a first ladder section; wherein the first ladder section comprises a first leg, a second leg, and first rungs that extend between the first leg and the second leg;
a second ladder section; wherein the second ladder section comprises a third leg, a fourth leg, and second rungs that extend between the third leg and the fourth leg;
a pivoting mechanism that pivotally couples the first ladder section to the second ladder section;
a blocker that is arranged to selectively prevent the ladder from being positioned in a folded position; and
a supporting element that extends above the first and second ladder sections.

2. The secure ladder according to claim 1 wherein the blocker is configured to move between (a) a blocking position in which the blocker is positioned, within a plane defined by the first leg and the third leg, between the first leg and the third leg, and (b) an unblocking position in which the blocker is positioned outside the plane defined by the first leg and the third leg.

3. The secure ladder according to claim 2 wherein the blocker is pivotally coupled to the first leg and is configured to pivot between the blocking position and the unblocking position.

4. The secure ladder according to claim 2 wherein the blocker is positioned at an upper half of the ladder.

5. The secure ladder according to claim 2 wherein the blocker is a plate that comprises a first edge and a second edge, wherein the first edge is oriented by a predefined angle to the second edge; wherein when the blocker is positioned in the blocking position and the first leg and the third leg reach the blocker then the first edge contacts the first leg and the the second edge contacts the third leg.

6. The secure ladder according to claim 1 comprising an additional blocker that is configured to move between (a) a blocking position in which the additional blocker is positioned, within a plane defined by the first second and the fourth leg, between the second leg and the fourth leg, and (b) an unblocking position in which the additional blocker is positioned outside the plane defined by the second leg and the fourth leg.

7. The secure ladder according to claim 6 wherein the additional blocker is pivotally coupled to the second leg and is configured to pivot between the blocking position and the unblocking position.

8. The secure ladder according to claim 6 wherein the additional blocker is parallel to the blocker when the additional blocker and the blocker are positioned in the blocking position.

9. The secure ladder according to claim 6 wherein the additional blocker is not parallel to the blocker when the additional blocker and the blocker are positioned in the unblocking position.

10. The secure ladder according to claim 6 wherein the additional blocker and the blocker are positioned outside a space defined by the first, second, third and fourth legs, when the additional blocker and the blocker are positioned in the unblocking position.

11. The secure ladder according to claim 1 further comprising a first stabilizing element and a second stabilizing element.

12. The secure ladder according to claim 11 wherein the first stabilizing element is fixed to the first leg and the second stabilizing element is fixed to the second leg; wherein the first stabilizing element has at least one first bottom surface that is aligned with a bottom end of the first leg; and wherein the second stabilizing element has at least one second bottom surface that is aligned with a bottom end of the second leg.

13. The secure ladder according to claim 12 wherein the first stabilizing element comprises a first triangular frame that extends outwardly from the first leg, wherein the first triangular frame is connected to the first leg and to the at least one first bottom surface.

14. The secure ladder according to claim 12 wherein the second stabilizing element comprises a second triangular frame that extends outwardly from the second leg, wherein the second triangular frame is connected to the second leg and to the at least one second bottom surface.

15. The secure ladder according to claim 1 wherein the supporting element comprises a base, a base holder and an upper structural element; wherein the base holder is connected to one of the legs of the secure ladder; wherein the base is coupled to the base holder and is connected to the upper structural element.

16. The secure ladder according to claim 15 wherein the base holder is configured to hold the base; wherein the base is connected to the upper structural element.

17. The secure ladder according to claim 16 wherein the upper structural element is a rod that extends above the first and second legs.

18. The secure ladder according to claim 16 wherein the base is configured to be inserted through one or more spaces defined by the base holder.

19. The secure ladder according to claim 18 wherein the base holder comprises multiple coaxial spaced apart rings.

20. The secure ladder according to claim 16 further comprising a support element that is height adjustable.

21. The secure ladder according to claim 20 wherein the upper structural element is a plate.

22. The secure ladder according to claim 20 comprising a locking element for locking the upper structural element to the upper structural element.
